(19) United States
(12) Patent Application Publication
(10) Pub. No.: US 2025/0182924 A1
(43) Pub. Date: Jun. 5, 2025

(54) Electric cable comprising a semiconductor layer having a smooth surface

(71) Applicant: NEXANS, Courbevoie (FR)

(72) Inventors: Christian KOELBLIN, MEXIMIEUX (FR); Gabriele PEREGO, MILAN (IT); Christelle MAZEL, RUY (FR); Charles BARUSTA, LYON (FR)

(21) Appl. No.: 18/695,263

(22) PCT Filed: Aug. 25, 2022
(86) PCT No.: PCT/FR2022/051611

§ 371 Date: Mar. 25, 2024

(30) Foreign Application Priority Data
Sep. 24, 2021 (FR) 2110066

(51) Int. Cl. H01B 1/20

(52) U.S. Cl. CPC H01B 1/20

(57) ABSTRACT

An electric cable has at least one semiconductor layer obtained from a polymer composition having at least 50% by weight of a propylene polymer, with respect to the total weight of polymer(s) in the polymer composition, and at least one conductive filler selected from acetylene blacks, and at most 10% by weight of polar polymer(s), with respect to the total weight of polymer(s) in the polymer composition.

The present invention relates to an electric cable comprising at least one semiconductor layer obtained from a polymer composition comprising at least 50% by weight of a propylene polymer, relative to the total weight of polymer(s) in the polymer composition, at least one conductive filler selected from acetylene blacks, and at most 10% by weight of polar polymer(s) relative to the total weight of polymer(s) in the polymer composition.

The invention applies typically, but not exclusively, to electric cables intended for energy transportation, in particular to DC or AC medium voltage (particularly from 6 to 45-60 kV) power cables or high-voltage (particularly greater than 60 kV and extending up to 800 kV) power cables, in the fields of wind, marine or terrestrial electricity transportation or else aeronautics. The invention applies in particular to electric cables comprising at least one semiconductor layer having a smooth surface state.

A semiconductor layer of an electric cable is generally obtained by dispersing conductive particles within a polymer matrix. However, during the manufacture of the compositions used to obtain these semiconductor layers, such particles are commonly difficult to disperse in the polymers used as the polymer matrix. During the extrusion of the semiconductor layers, either around the conductor of the cable or around the insulating layer, poorly-incorporated carbon black particles can be found at the interface between a semiconductor layer and the insulating layer and can form protrusions surrounded by the insulating layer. These protrusions will lead to a localized increase in the electric field which can cause premature aging of the cable, it being possible for said aging to cause electrical breakdown.

There is therefore a need for semiconductor layers based on propylene polymer(s) for electric cables that have an improved surface state.

An internal or external semiconductor layer for an electric cable, obtained from a thermoplastic material based on a polypropylene matrix mixed with a dielectric material, the thermoplastic material having an enthalpy of fusion of 15 to 50 J/g and the polypropylene matrix being obtained from a propylene material selected from a heterophasic propylene-ethylene copolymer having an enthalpy of fusion of 15 to 50 J/g, and intimate mixing of said heterophasic copolymer and of a propylene homopolymer or propylene-ethylene copolymer having an enthalpy of fusion of greater than 50 J/g, is known from international application WO2018/100409 A1. In the examples, carbon black is used as conductive filler. The surface state of the semiconductor layer as described is not optimized.

One aim of the present invention is to overcome the disadvantages of the prior art techniques by proposing an electric cable, particularly medium-voltage or high-voltage electric cable, based on propylene polymer(s), said cable having an improved surface state (i.e. a surface state in which protrusions are reduced and/or the surface state has a smooth appearance), preferably while ensuring good thermomechanical properties. This aim is achieved by the invention described below.

A first subject of the invention is an electric cable comprising at least one semiconductor layer obtained from a polymer composition comprising at least 50% by weight of a propylene polymer and at most 10% by weight of polar polymer(s), relative to the total weight of polymer(s) in the polymer composition, and at least one conductive filler selected from acetylene blacks.

Thus, by virtue of the combination of at least 50% by weight of a propylene polymer, relative to the total weight of polymer(s) in the polymer composition, and of at least one conductive filler selected from acetylene blacks, while having at most 10% by weight of polar polymer(s), relative to the total weight of polymer(s) in the polymer composition, the semiconductor layer thus obtained has an improved surface state, in particular a smooth appearance, and/or has a reduced number of protrusions, preferably while ensuring good mechanical properties at high temperature.

### The Conductive Filler

The polymer composition comprises at least one conductive filler selected from acetylene blacks, particularly in a sufficient amount to make the layer semiconductive.

The polymer composition can comprise approximately at least 6% by weight of conductive filler, preferably approximately at least 15% by weight of conductive filler, and particularly preferably approximately at least 25% by weight of conductive filler, relative to the total weight of the polymer composition.

The polymer composition can comprise approximately at most 45% by weight of conductive filler, and preferably approximately at most 40% by weight of conductive filler, relative to the total weight of the polymer composition.

The conductive filler is an electrically conductive filler.

The conductive filler is selected from acetylene blacks.

Unlike furnace blacks, graphites, or other conductive fillers, acetylene blacks have the advantages of having a lower amount of chemical impurities (for instance ionic contaminants and trace oxides), having good intrinsic electrical conductivity and making it possible to obtain a good surface quality.

The conductive filler may be in the form of particles, nodules or aggregates, preferably with a mean primary particle size ranging approximately from 20 to 50 nm, particularly preferably ranging approximately from 30 to 40 nm.

Considering a number of particles, nodules or aggregates of the conductive filler powder according to the invention, the term “dimension” represents the D50 size distribution, this distribution conventionally being determined by methods which are well known to those skilled in the art.

The dimension of the conductive particle(s) according to the invention can for example be determined by microscopy, particularly by scanning electron microscopy (SEM), transmission electron microscopy (TEM) or by laser diffraction.

The D50 size distribution is preferably measured by laser diffraction, for example by means of a laser diffraction particle size analyzer. The D50 size distribution indicates that 50% by volume of the population of particles has an equivalent sphere diameter that is less than the given value.

The presence of at least 50% by weight of a propylene polymer and of at most 10% by weight of polar polymer(s) relative to the total weight of polymer(s) in the polymer composition makes it possible to incorporate enough conductive filler to make the layer semiconductive, while ensuring good mechanical properties. Conversely, some ethylene polymers such as LDPE do not make it possible to incorporate enough conductive filler without preventing the degradation of the mechanical properties.

The conductive filler may have a specific surface area, according to the BET method, ranging approximately from 50 to 150 m²/g, preferably approximately from 70 to 140 m²/g, and particularly preferably approximately from 80 to 120 m²/g.

In the present description, the specific surface area of the inorganic conductive filler may be readily determined according to standard DIN 9277 (2010).

The conductive filler preferably comprises a small amount of ionic substances, typically less than 100 ppm, for example less than 10 ppm. This amount can for example be determined by inductively-coupled plasma spectroscopy or the method described in J. Tanaka, “Interfacial Aging Phenomena In Power Cable Insulation systems”, Institute of Materials Science, University of Connecticut, Progress Report No. 8 and 9, Sep. 13, 1988 ([0019]).

The acetylene blacks of the invention are preferably selected from those having at least one of the following characteristics:
an iodine absorption number ranging approximately from 45 g/kg to 300 g/kg, measured according to standard ASTM D-1510,
a DBP (dibutyl phthalate) oil absorption number ranging approximately from 100 cm³/100 g to 300 cm³/100 g, measured according to standard ASTM D-2414,
a bulk density ranging approximately from 200 g/ml to 400 g/ml, measured according to standard ASTM D-1513,
a CTAB (cetyltrimethylammonium bromide) specific surface area ranging approximately from 40 to 300 m²/g, measured according to standard ASTM D-6556,
a sulfur content of less than 200 ppm.

### The Propylene Polymer

In the present description, “polymer” means any type of polymer, for instance homopolymers or copolymers (e.g. block copolymer, random copolymer, terpolymer, etc.).

The polymer composition comprises approximately at least 50% by weight, preferably approximately at least 60% by weight, particularly preferably approximately at least 70% by weight, and more particularly preferably approximately at least 80% by weight of propylene polymer(s) relative to the total weight of polymer(s) in the polymer composition.

The propylene polymer may be a propylene homopolymer or copolymer P₁, and preferably a propylene copolymer P₁.

The propylene homopolymer P₁ preferably has a modulus of elasticity ranging approximately from 1250 to 1600 MPa.

In the present description, the modulus of elasticity or Young's modulus (also known as tensile modulus) of a polymer is well known to those skilled in the art and can be readily determined according to standard ISO 527-1, -2 (2012). Standard ISO 527 has a first part, denoted “ISO 527-1”, and a second part, denoted “ISO 527-2”, specifying the test conditions relating to the general principles of the first part of standard ISO 527.

As examples of propylene copolymers P₁, mention may be made of propylene-olefin copolymers, the olefin being selected particularly from ethylene and a α₁-olefin other than propylene.

The ethylene or a1-olefin other than propylene of the propylene-olefin copolymer preferably represents at most approximately 45 mol %, particularly preferably at most approximately 40 mol %, and more particularly preferably at most approximately 35 mol %, relative to the total number of moles of propylene-olefin copolymer.

The molar percentage of ethylene or of a1-olefin in the propylene copolymer P₁ can be determined by nuclear magnetic resonance (NMR), for example according to the method described in Masson et al., Int. J. Polymer Analysis & Characterization, 1996, Vol. 2, 379-393.

The α₁-olefin other than the propylene may correspond to the formula CH₂═CH—R¹ in which R¹ is a linear or branched alkyl group having from 2 to 12 carbon atoms, in particular selected from the following olefins: 1-butene, 1-pentene, 4-methyl-1-pentene, 1-hexene, 1-octene, 1-decene, 1-dodecene, and a mixture thereof.

Propylene-ethylene copolymers are preferred as propylene copolymer P₁.

The propylene copolymer P₁ may be a homophasic propylene copolymer or a heterophasic propylene copolymer, and preferably a (heterophasic) propylene copolymer.

In the invention, the homophasic propylene copolymer P₁ preferably has a modulus of elasticity ranging approximately from 600 to 1200 MPa, and particularly preferably ranging approximately from 800 to 1100 MPa.

The homophasic propylene copolymer P₁ is advantageously a random propylene copolymer P₁.

The ethylene or α₁-olefin other than propylene of the homophasic propylene copolymer P₁ preferably represents at most approximately 20 mol %, particularly preferably at most approximately 15 mol %, and more particularly preferably at most approximately 10 mol %, relative to the total number of moles of homophasic propylene copolymer P₁.

The ethylene or α₁-olefin other than propylene of the homophasic propylene copolymer P₁ may represent at least approximately 1 mol % relative to the total number of moles of homophasic propylene copolymer P₁.

As examples of a random propylene copolymer P₁, mention may be made of that sold by Borealis under the reference Bormed® RB 845 MO or that sold by Total Petrochemicals under the reference PPR3221.

The heterophasic (or heterophase) propylene copolymer P₁ may comprise a thermoplastic phase of propylene type, and a thermoplastic elastomeric phase of ethylene-α₂-olefin copolymer type.

The α₂-olefin of the thermoplastic elastomeric phase of the heterophasic propylene copolymer P₁ may be propylene.

The thermoplastic elastomeric phase of the heterophasic propylene copolymer P₁ may represent at least approximately 20% by weight, and preferably at least approximately 45% by weight, relative to the total weight of the heterophasic propylene copolymer P₁.

The heterophasic propylene copolymer P₁ preferably has a modulus of elasticity ranging approximately from 50 to 1200 MPa, and particularly preferably: either a modulus of elasticity ranging approximately from 50 to 550 MPa and more particularly preferably ranging approximately from 50 to 300 MPa, or a modulus of elasticity ranging approximately from 600 to 1200 MPa and more particularly preferably ranging approximately from 800 to 1200 MPa.

As examples of a heterophasic propylene copolymer, mention may be made of the heterophasic propylene copolymer sold by LyondellBasell under the reference Adflex® Q 200 F, or the heterophasic copolymer sold by LyondellBasell under the reference Moplen EP®2967.

The propylene homopolymer or copolymer P₁ may have a melting point of greater than approximately 110° C., preferably greater than approximately 130° C., particularly preferably greater than approximately 135° C., and more particularly preferably ranging approximately from 140 to 170° C.

The propylene homopolymer or copolymer P₁ may have an enthalpy of fusion ranging approximately from 20 to 100 J/g.

The propylene homopolymer P₁ preferably has an enthalpy of fusion ranging approximately from 80 to 90 J/g.

The homophasic propylene copolymer P₁ preferably has an enthalpy of fusion ranging approximately from 40 to 90 J/g, and particularly preferably ranging from 50 to 85 J/g.

The heterophasic propylene copolymer P₁ preferably has an enthalpy of fusion ranging approximately from 20 to 50 J/g.

The propylene homopolymer or copolymer P₁ may have a melt flow index ranging from 0.5 to 3 g/10 min; in particular determined at approximately 230° C. with a load of approximately 2.16 kg according to standard ASTM D1238-00 or standard ISO 1133.

The homophasic propylene copolymer P₁ preferably has a melt flow index ranging from 1.0 to 2.75 g/10 min; and more preferably still ranging from 1.2 to 2.5 g/10 min; in particular determined at approximately 230° C. with a load of approximately 2.16 kg according to standard ASTM D1238-00 or standard ISO 1133.

The heterophasic propylene copolymer P₁ may have a melt flow index ranging from 0.5 to 3 g/10 min; and preferably ranging approximately from 0.6 to 1.2 g/10 min; in particular determined at approximately 230° C. with a load of approximately 2.16 kg according to standard ASTM D1238-00 or standard ISO 1133.

The propylene homopolymer or copolymer P₁ may have a density ranging approximately from 0.81 to 0.92 g/cm³; in particular determined according to standard ISO 1183A (at a temperature of 23° C.).

The propylene copolymer P₁ preferably has a density ranging from 0.85 to 0.91 g/cm³; and particularly preferably ranging from 0.87 to 0.91 g/cm³; in particular determined according to standard ISO 1183A (at a temperature of 23° C.).

The polymer composition may comprise a plurality of propylene polymers, and in particular a plurality of different propylene copolymers P₁, particularly two different propylene copolymers P₁, said propylene copolymers P₁ being as defined above.

In particular, the polymer composition may comprise a homophasic propylene copolymer (as first propylene copolymer P₁) and a heterophasic propylene copolymer (as second propylene copolymer P₁), or two different heterophasic propylene copolymers, and preferably a homophasic propylene copolymer and a heterophasic propylene copolymer.

When the polymer composition comprises a homophasic propylene copolymer and a heterophasic propylene copolymer, said heterophasic propylene copolymer preferably has a modulus of elasticity ranging approximately from 50 to 300 MPa.

According to one embodiment of the invention, the two heterophasic propylene copolymers have a different modulus of elasticity. Preferably, the polymer composition comprises a first heterophasic propylene copolymer having a modulus of elasticity ranging approximately from 50 to 550 MPa, and particularly preferably ranging approximately from 50 to 300 MPa; and a second heterophasic propylene copolymer having a modulus of elasticity ranging approximately from 600 to 1200 MPa and more particularly preferably ranging approximately from 800 to 1200 MPa.

Advantageously, the first and second heterophasic propylene copolymers have a melt flow index as defined in the invention.

These combinations of propylene copolymers P₁ may advantageously make it possible to improve the mechanical properties of the semiconductor layer. In particular, the combination makes it possible to obtain optimized mechanical properties of the semiconductor layer particularly in terms of elongation at break and of flexibility; and/or makes it possible to form a more homogeneous semiconductor layer; in particular it promotes the dispersion of the liquid dielectric in the propylene polymer(s) of said semiconductor layer.

According to a preferred embodiment of the invention, the propylene copolymer P₁, or the propylene copolymers P₁ when there is a plurality thereof, represent(s) at least approximately 50% by weight, preferably approximately from 55 to 90% by weight, and more particularly preferably approximately from 60 to 90% by weight, relative to the total weight of polymer(s) in the polymer composition.

The homophasic propylene copolymer P₁ may represent at least 20% by weight, and preferably from 30 to 70% by weight, relative to the total weight of polymer(s) in the polymer composition.

The heterophasic propylene copolymer P₁, or the heterophasic propylene copolymers P₁ when there is a plurality thereof, may represent at least approximately from 5 to 95% by weight, preferably approximately from 50 to 90% by weight, and more particularly preferably approximately from 60 to 80% by weight, relative to the total weight of polymer(s) in the polymer composition.

### Other Polymers in the Polymer Composition

The polymer composition may further comprise an olefin homopolymer or copolymer P₂.

Said olefin homopolymer or copolymer P₂ is preferably other than said propylene homopolymer or copolymer P₁.

The olefin of the olefin copolymer P₂ may be selected from ethylene and an α-olefin corresponding to the formula CH₂═CH—R², in which R² is a linear or branched alkyl group having from 1 to 12 carbon atoms.

The α-olefin is preferably selected from the following olefins: propylene, 1-butene, isobutylene, 1-pentene, 4-methyl-1-pentene, 1-hexene, 1-octene, 1-decene, 1-dodecene, and a mixture thereof.

The α-olefin of propylene, 1-hexene or 1-octene type is particularly preferred.

The combination of polymers P₁ and P₂ makes it possible to obtain a polymer composition having good mechanical properties, particularly in terms of modulus of elasticity, and good electrical properties.

The olefin homopolymer or copolymer P₂ is preferably an ethylene polymer.

The ethylene polymer preferably comprises at least approximately 80 mol % of ethylene, particularly preferably at least approximately 90 mol % of ethylene, and more particularly preferably at least approximately 95 mol % of ethylene, relative to the total number of moles of the ethylene polymer.

According to a preferred embodiment of the invention, the ethylene polymer is selected from low-density ethylene polymers (LDPE), linear low-density ethylene polymers (LLDPE), medium-density ethylene polymers (MDPE), and high-density ethylene polymers (HDPE); in particular according to standard ISO 1183A (at a temperature of 23° C.).

Preferably, the ethylene polymer is an LLDPE.

In the present description, the expression “low density” means having a density ranging approximately from 0.91 to 0.925, said density being measured according to standard ISO 1183A (at a temperature of 23° C.).

In the present description, the expression “medium density” means having a density ranging approximately from 0.926 to 0.940, said density being measured according to standard ISO 1183A (at a temperature of 23° C.).

In the present description, the expression “high density” means having a density ranging from 0.941 to 0.965, said density being measured according to standard ISO 1183A (at a temperature of 23° C.).

The ethylene polymer preferably comprises at least approximately 80 mol % of ethylene, particularly preferably at least approximately 90 mol % of ethylene, and more particularly preferably at least approximately 95 mol % of ethylene, relative to the total number of moles of the ethylene polymer.

The molar percentage of ethylene in the ethylene polymer can be determined by nuclear magnetic resonance (NMR), for example according to the method described in Masson et al., Int. J. Polymer Analysis & Characterization, 1996, Vol. 2, 379-393.

The ethylene polymer preferably has a flexural modulus of at least 150 MPa, and particularly preferably of at least 400 MPa, determined according to the ISO 178 method. In addition, in comparison to other partially crystalline ethylene polymers, the ethylene polymer preferably has a melting point of at least 110° C. measured by DSC.

According to a preferred embodiment of the invention, the olefin homopolymer or copolymer P₂ represents approximately from 5 to 30% by weight, and particularly preferably approximately from 10 to 20% by weight, relative to the total weight of polymer(s) in the polymer composition.

According to a particularly preferred embodiment of the invention, the polymer composition comprises two propylene copolymers P₁, such as a homophasic propylene copolymer and a heterophasic propylene copolymer, or two different heterophasic propylene copolymers; and an olefin homopolymer or copolymer P₂ such as an ethylene polymer. This combination of propylene copolymers P₁ and of an olefin homopolymer or copolymer P₂ makes it possible to further improve the mechanical properties of the semiconductor layer while ensuring good thermal conductivity.

The propylene copolymer(s) P₁ and the olefin homopolymer or copolymer P₂ may represent at least 80% by weight, preferably at least 90% by weight, and particularly preferably at least 95% by weight, relative to the total weight of polymer(s) in the polymer composition.

More particularly, the polymer composition may solely comprise the propylene copolymer(s) P₁ and the olefin homopolymer or copolymer P₂, as are defined in the invention, as polymer(s).

The propylene copolymer(s) P₁ and the olefin homopolymer or copolymer P₂ are not necessarily miscible within the polymer composition. In other words, their miscibility is not essential in order to obtain a semiconductor layer having an improved surface state, particularly a smooth appearance and/or having a reduced number of protrusions, preferably while ensuring good mechanical properties.

The polymer composition of the cable of the invention comprises approximately at most 10% by weight, preferably approximately at most 8% by weight, and particularly preferably approximately at most 5% by weight of polar polymer(s) relative to the total weight of polymer(s) in the polymer composition.

In the present description, the expression “polar” means that the polymer of this type comprises one or more polar functions, for instance acetate, acrylate, hydroxyl, nitrile, carboxyl, carbonyl, ether, ester groups, or any other groups having a polar nature that are well known in the prior art, such as in particular silane groups. For example, a polar polymer is a polymer selected from ethylene copolymers of the ethylene-vinyl acetate (EVA) copolymer type, ethylene-butyl acrylate (EBA) copolymer type, ethylene-ethyl acrylate (EEA) copolymer type, ethylene-methyl acrylate (EMA) copolymer type, and ethylene-acrylic acid (EAA) copolymer type.

The polymer composition preferably does not comprise polar polymer(s). This is because polar polymers can reduce resistance to thermal aging (i.e. thermal stability) of the semiconductor layer of the invention; when they are used in large amounts, they can make the semiconductor layer strippable which is not the desired effect in the context of the present invention, and polar residues can migrate into the adjacent insulating layer and thus degrade the dielectric loss angle (tan delta) and also negatively influence the distribution of space charges.

The composition of the invention is a homogeneous composition in that it is in the form of a single polymer phase in so far as the polymers are miscible, or in the form of at least two phases, the first being uniformly dispersed in the second to form a homogeneous composition.

When the composition is in the form of at least two phases, the presence of a plurality of phases can originate from the mixture of two different polyolefins, such as a mixture of different propylene polymers or a mixture of a propylene polymer and of an ethylene polymer.

The polymers used in the polymer composition have the advantage of not producing any significant phase separation in the melt state, facilitating the mixing thereof and the extrusion thereof to form the semiconductor layer.

### The Liquid Dielectric

The polymer composition of the invention preferably further comprises a liquid dielectric, particularly forming an intimate mixture with the polymers of the polymer composition.

The liquid dielectric improves the conductive filler/propylene polymer interface. The presence of the liquid dielectric thus makes it possible to obtain better dielectric properties (i.e. better electrical insulation), and particularly better dielectric strength of the semiconductor layer obtained from the polymer composition. Its presence can also make it possible to improve the mechanical properties and/or aging resistance of said semiconductor layer.

The liquid dielectric is also well known to those skilled in the art by the names “dielectric oil” or “dielectric fluid”.

As examples of liquid dielectric, mention may be made of mineral oils (e.g. naphthenic oils, paraffinic oils or aromatic oils); plant oils (e.g. soybean oil, linseed oil, rapeseed oil, corn oil or castor oil) or synthetic oils such as aromatic hydrocarbons (alkylbenzenes, alkylnaphthalenes, alkylbiphenyls, alkyldiarylethylenes, etc.), silicone oils, alkyl ethers, organic esters or aliphatic hydrocarbons.

Aromatic hydrocarbons, silicone oils and aliphatic hydrocarbons are preferred as synthetic oils.

According to a particular embodiment, the liquid dielectric represents approximately from 1 to 20% by weight, preferably approximately from 2 to 15% by weight, and particularly preferably approximately from 3 to 12% by weight, relative to the total weight of the polymer composition.

The liquid dielectric preferably comprises at least one mineral oil.

The mineral oil is generally liquid at approximately 20-25° C.

The mineral oil is advantageously selected from naphthenic oils and paraffinic oils.

The mineral oil is obtained from the refining of crude petroleum.

According to a particularly preferred embodiment of the invention, the mineral oil comprises a content of paraffinic carbon (Cp) ranging approximately from 45 to 65 atomic %, a content of naphthenic carbon (Cn) ranging approximately from 35 to 55 atomic %, and a content of aromatic carbon (Ca) ranging approximately from 0.5 to 10 atomic %.

The liquid dielectric can comprise approximately at least 70% by weight of mineral oil, preferably approximately at least 80% by weight of mineral oil, and particularly preferably approximately at least 90% by weight of mineral oil, relative to the total weight of the liquid dielectric.

According to a preferred embodiment of the invention, the liquid dielectric comprises a mineral oil and at least one polar compound of benzophenone or acetophenone type or a derivative thereof.

In a particular embodiment, the polar compound of benzophenone or acetophenone type or a derivative thereof represents approximately at least 2.5% by weight, preferably approximately at least 3.5% by weight, and particularly preferably approximately at least 4% by weight, relative to the total weight of the liquid dielectric.

According to a preferred embodiment of the invention, the polar compound of benzophenone or acetophenone type or a derivative thereof is selected from benzophenone, dibenzosuberone, fluorenone and anthrone. Benzophenone is particularly preferred.

The liquid dielectric may comprise approximately at most 30% by weight, preferably approximately at most 20% by weight, even more preferentially approximately at most 15% by weight, of polar compound of benzophenone or acetophenone type or a derivative thereof, relative to the total weight of the liquid dielectric. This maximum amount makes it possible to ensure moderate, or even low, dielectric losses (e.g. less than approximately 10-3) and also to prevent the liquid dielectric from migrating out of the electrically insulating layer.

According to a preferred embodiment of the invention, the polar compound of benzophenone or acetophenone type or a derivative thereof is selected from benzophenone, dibenzosuberone, fluorenone and anthrone. Benzophenone is particularly preferred.

### Additives

The polymer composition may further comprise one or more additives.

The additives are well known to those skilled in the art.

The additives may be selected from antioxidants, processing aids such as lubricants, metal deactivators, compatibilizers, coupling agents, anti-UV agents, agents for reducing water treeing, pigments, and a mixture thereof.

The polymer composition can typically comprise approximately from 0.01 to 5% by weight, and preferably approximately from 0.1 to 2% by weight, of additive(s), relative to the total weight of the polymer composition.

More particularly, antioxidants make it possible to protect the polymer composition from thermal stresses brought about during the steps of manufacturing the cable or operating the cable.

The antioxidant may be selected from hindered phenols, aromatic amines, nitrogenous aromatic heterocycles, sulfur-based antioxidants and phosphorus-based antioxidants, and preferably from hindered phenols.

As examples of hindered phenols, mention may be made of pentaerythritol tetrakis(3-(3,5-di-tert-butyl-4-hydroxyphenyl) propionate) (Irganox® 1010), octadecyl 3-(3,5-di-tert-butyl-4-hydroxyphenyl) propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thiobis(6-tert-butyl-4-methylphenol) (Irganox® 1081), 2,2′-thiodiethylenebis [3-(3,5-di-tert-butyl-4-hydroxyphenyl) propionate] (Irganox® 1035), 2,2′-methylenebis(6-tert-butyl-4-methylphenol) or tris(3,5-di-tert-butyl-4-hydroxybenzyl) isocyanurate (Irganox® 3114).

As examples of aromatic amines, mention may be made of phenylenediamines (e.g. paraphenylenediamines such as 1PPD or 6PPD), styrene diphenylamines, diphenylamines, or 4-(1-methyl-1-phenylethyl)-N-[4-(1-methyl-1-phenylethyl)phenyl]aniline (Naugard 445).

As examples of nitrogenous aromatic heterocycles, mention may be made of mercaptobenzimidazoles or quinoline derivatives such as polymerized 2,2,4-trimethyl-1,2-dihydroquinolines (TMQ), and preferably mercaptobenzimidazoles.

As examples of sulfur-based antioxidants, mention may be made of thioethers such as didodecyl-3,3′-thiodipropionate (Irganox® PS800), distearylthiodipropionate or dioctadecyl-3,3′-thiodipropionate (Irganox® PS802), bis [2-methyl-4-{3-n-(C₁₂ or C₁₄)alkyl thiopropionyloxy}-5-tert-butylphenyl]sulfide, thiobis-[2-tert-butyl-5-methyl-4,1-phenylene]bis [3-(dodecylthio) propionate], or 4,6-bis(octylthiomethyl)-o-cresol (Irganox® 1520 or Irgastab® KV10).

As examples of phosphorus-based antioxidants, mention may be made of phosphites or phosphonates, such as tris(2,4-di-tert-butylphenyl)phosphite (Irgafos® 168) or bis(2,4-di-tert-butylphenyl) pentaerythritol diphosphite (Ultranox® 626).

The metal deactivator may be selected from nitrogenous aromatic heterocycles and aromatic compounds comprising at least one —NH—C(═O)— function, and preferably from aromatic compounds comprising at least one —NH—C(═O)— function. The presence of oxygen in the metal deactivator is important in order to be able to sustainably immobilize the metal ions.

As examples of nitrogenous aromatic heterocycles, mention may be made of quinoline derivatives such as polymerized 2,2,4-trimethyl-1,2-dihydroquinolines (TMQ).

As examples of aromatic compounds comprising at least one-NH—C(═O)— function, mention may be made of those comprising two —NH—C(═O)— functions, preferably comprising two covalently-bonded —NH—C(═O)— functions, and more particularly preferably comprising a divalent —NH—C(═O)—C(═O)—NH— or —C(═O)—NH—NH—C(═O)— group, such as 2,2′-oxamidobis [ethyl-3-(3,5-di-tert-butyl-4-hydroxyphenyl) propionate] (Naugard XL-1), 2′,3-bis [[3-[3,5-di-tert-butyl-4-hydroxyphenyl]propionyl]] propionohydrazide or 1,2-bis(3,5-di-tert-butyl-4-hydroxyhydrocinnamoyl) hydrazine (Irganox® 1024 or Irganox® MD 1024), or oxalyl bis(benzylidenehydrazide) (OABH).

The polymer composition of the semiconductor layer of the invention is a thermoplastic polymer composition. Therefore, it is not crosslinkable.

In particular, the polymer composition does not comprise crosslinking agents, silane-type coupling agents, peroxides and/or additives which enable crosslinking. This is because such agents degrade the polymer(s) of the polymer composition.

The polymer composition is preferably recyclable.

The composition may further comprise inert inorganic fillers such as chalk, kaolin or talcum; and/or halogen-free mineral fillers intended to improve the fire response of the polymer composition.

The inert inorganic fillers and/or halogen-free mineral fillers may represent approximately at most 30% by weight, preferably approximately at most 20% by weight, particularly preferably approximately at most 10% by weight, and more particularly preferably approximately from 0.1 to 5% by weight, relative to the total weight of the polymer composition.

In order to ensure the electric cable is halogen-free flame retardant (HFFR), the cable of the invention preferentially does not comprise any halogenated compounds. These halogenated compounds may be of any nature, for instance fluoropolymers or chloropolymers such as polyvinyl chloride (PVC), halogenated plasticizers, halogenated mineral fillers, etc.

### The Semiconductor Layer

The semiconductor layer of the cable of the invention is preferably a non-crosslinked layer, or in other words a thermoplastic layer.

In the invention, the expression “non-crosslinked layer” or “thermoplastic layer” means a layer for which the gel content according to standard ASTM D2765-01 (xylene extraction) is approximately at most 30%, preferably approximately at most 20%, particularly preferably approximately at most 10%, more particularly preferably approximately at most 5%, and even more particularly preferably 0%.

In one embodiment of the invention, the semiconductor layer, which is preferably non-crosslinked, has a tensile strength of approximately at least 7 MPa, preferably approximately at least 10 MPa, and particularly preferably approximately at least 12.5 MPa.

The tensile strength is measured by a tensile test on a dumbbell-shaped H2 test specimen, in particular at a pulling rate of 25 mm/min.

In a particularly preferred embodiment of the invention, the semiconductor layer, which is preferably non-crosslinked, has an elongation at break of approximately at least 150%, preferably approximately at least 250%, and particularly preferably approximately at least 350%.

The elongation at break is measured by a tensile test on a dumbbell-shaped H2 test specimen, in particular at a pulling rate of 25 mm/min.

The semiconductor layer of the cable of the invention is preferably a recyclable layer.

The semiconductor layer of the invention can be an extruded layer, in particular extruded using processes which are well known to those skilled in the art.

The semiconductor layer has a variable thickness which depends on the type of cable envisaged. In particular, when the cable in accordance with the invention is a medium-voltage cable, the thickness of the semiconductor layer is typically approximately from 0.3 to 1.5 mm, and more particularly approximately 0.5 mm. When the cable in accordance with the invention is a high-voltage cable, the thickness of the semiconductor layer typically varies from 1.0 to 4 mm (for voltages of approximately 150 kV) and can be as much as thicknesses ranging approximately from 3 to 5 mm for voltages of greater than 150 kV (very high-voltage cables). The abovementioned thicknesses typically depend, inter alia, on the size of the elongate electrically conductive element.

In the present description, “semiconductor layer” means a layer for which the electrical conductivity can be strictly greater than 1×10⁻⁸ S/m (Siemens per meter), preferably at least 1×10⁻³ S/m, and can preferably be less than 1×10³ S/m, measured at 25° C. using direct current.

In the present description, “semiconductor layer” means a layer for which the volume resistivity (measured at 90° C.) is less than or equal to 1000 [Ω*m].

The semiconductor layer of the invention can comprise at least 50% by weight of a propylene polymer, at most 10% by weight of polar polymer(s), relative to the total weight of polymer(s) in the polymer composition, and at least one conductive filler selected from acetylene blacks, and optionally one or more additives, the abovementioned ingredients being as defined in the invention.

The proportions of the various ingredients in the semiconductor layer can be identical to those as described in the invention for the same ingredients in the polymer composition.

### The Cable

The electric cable can comprise at least one elongate electrically conductive element and the semiconductor layer as defined in the invention, said semiconductor layer surrounding said elongate electrically conductive element.

The elongate electrically conductive element may be a single-body conductor, for instance a metal wire, or a multi-body conductor, such as a plurality of twisted or untwisted metal wires.

The elongate electrically conductive element may be made of aluminum, aluminum alloy, copper, copper alloy, and preferably copper or copper alloy.

The cable may further comprise an electrically insulating layer.

According to the present invention, the expression “electrically insulating layer” means a layer for which the electrical conductivity may be approximately at most 1×10⁻⁸ S/m (Siemens per meter), preferably approximately at most 1×10⁻⁹ S/m, and particularly preferably approximately at most 1×10⁻¹⁰ S/m (Siemens per meter), measured at 25° C. using direct current.

The electrically insulating layer more particularly has an electrical conductivity which is less than that of the semiconductor layer. More particularly, the electrical conductivity of the semiconductor layer may be at least 10 times greater than the electrical conductivity of the electrically insulating layer, preferably at least 100 times greater than the electrical conductivity of the electrically insulating layer, and particularly preferably at least 1000 times greater than the electrical conductivity of the electrically insulating layer.

The electrically insulating layer of the invention preferably surrounds the elongate electrically conductive element.

The electrically insulating layer may be an internal or external semiconductor layer.

In other words, when the semiconductor layer is an internal semiconductor layer, the electrically insulating layer surrounds the semiconductor layer.

In a preferred embodiment, the internal semiconductor layer is in direct physical contact with the elongate electrically conductive element.

In the present description, the expression “in direct physical contact” means that there is no other layer of any nature whatsoever inserted between said elongate electrically conductive element and the semiconductor layer. In other words, the cable does not comprise any intermediate layer(s), particularly layer(s) comprising at least one polymer, which are positioned between said elongate electrically conductive element and the semiconductor layer.

In a preferred embodiment, the internal semiconductor layer is in direct physical contact with the electrically insulating layer.

When the semiconductor layer is an external semiconductor layer, the latter can surround the electrically insulating layer.

In a preferred embodiment, the external semiconductor layer is in direct physical contact with the electrically insulating layer.

The semiconductor layer of the cable of the invention is preferably an internal semiconductor layer. This is because, in AC high-voltage cable applications, it is particularly advantageous for at least the internal semiconductor layer between the elongate electrically conductive element and the electrically insulating layer to have a smooth surface state, because the AC electric field gradient in the cable under operating conditions or test conditions is higher in this area.

The electrically insulating layer is preferably made of a thermoplastic polymer material, and particularly preferably is obtained from a polymer composition comprising at least one propylene-based thermoplastic polymer material, particularly comprising at least one homophasic propylene homopolymer or copolymer and/or at least one heterophasic propylene homopolymer or copolymer, and optionally at least one ethylene polymer.

According to a preferred embodiment of the invention, the electric cable comprises a plurality of semiconductor layers surrounding the elongate electrically conductive element, at least one of the semiconductor layers being as defined in the invention (or being obtained from a polymer composition as defined in the invention).

According to a particularly preferred embodiment of the invention, the cable comprises:
at least one elongate electrically conductive element, particularly positioned at the center of the cable,
a first semiconductor layer (internal semiconductor layer) surrounding the elongate electrically conductive element,
an electrically insulating layer surrounding the first semiconductor layer, and
a second semiconductor layer (external semiconductor layer) surrounding the electrically insulating layer,
   at least one of the semiconductor layers, preferably the first semiconductor layer and particularly preferably both semiconductor layers, being as defined in the invention (or being obtained from a polymer composition as defined in the invention).

In a particular embodiment, the first semiconductor layer, the electrically insulating layer and the second semiconductor layer form a three-layer insulation. In other words, the electrically insulating layer is in direct physical contact with the first semiconductor layer, and the second semiconductor layer is in direct physical contact with the electrically insulating layer.

The cable may further comprise an outer protective sheath surrounding the elongate electrically conductive element, and preferably surrounding the semiconductor layer as defined in the invention.

The outer protective sheath may be in direct physical contact with said semiconductor layer, more particularly when the semiconductor layer is an external semiconductor layer.

The outer protective sheath may be an electrically insulating sheath.

The electric cable may further comprise an electric screen (e.g. metallic) surrounding the semiconductor layer as defined in the invention. In this case, the outer protective sheath surrounds said electric screen and the electric screen is between the outer protective sheath and the semiconductor layer.

This metal screen may be a “wire-like” screen composed of a set of copper or aluminum conductors arranged around and along the second semiconductor layer, a “strip-like” screen composed of one or more copper or aluminum conductive metal strips, optionally helically wound around the semiconductor layer, or an aluminum conductive metal strip laid longitudinally around the semiconductor layer and sealed using adhesive in the areas in which parts of said strip overlap, or a “seal-like” screen of the metal tube type, optionally composed of lead or lead alloys and surrounding the semiconductor layer. This final type of screen particularly makes it possible to form a barrier against moisture which tends to penetrate the electric cable radially.

The metal screen of the electric cable of the invention may comprise a “wire-like” screen and a “seal-like” screen or a “wire-like” screen and a “strip-like” screen.

All types of metal screens can serve to ground the electric cable and can thus transport fault currents, for example in the event of a short-circuit in the network in question.

Other layers, such as layers that swell in the presence of moisture, can be added between the second semiconductor layer and the metal screen, these layers making it possible to seal the electric cable longitudinally against water.

The cable of the invention more particularly relates to the field of electric cables operating using direct current (DC) or alternating current (AC).

### Method for Manufacturing the Cable

The electric cable in accordance with the first subject of the invention may be obtained according to a method comprising at least a step 1) of extruding the polymer composition as defined in the first subject of the invention around an elongate electrically conductive element in order to obtain an (extruded) semiconductor layer surrounding said elongate electrically conductive element.

Step 1) can be carried out using techniques which are well known to those skilled in the art, for example using an extruder.

During step 1), the composition at the extruder outlet is said to be “non-crosslinked”, with the working time and temperature within the extruder being optimized accordingly.

At the extruder outlet, therefore, an extruded layer is obtained around said electrically conductive element, which extruded layer may or may not be in direct physical contact with said elongate electrically conductive element.

Preferably, the method does not comprise a step of crosslinking the layer obtained in step 1).

The electrically insulating layer and/or the semiconductor layer(s) of the electric cable of the invention can be obtained by successive extrusion or by co-extrusion.

Prior to the extrusion of each of these layers around at least one elongate electrically conductive element, all the constituents required to form each of these layers can be metered out and mixed in a continuous mixer of the BUSS co-kneader type, twin-screw extruder type or another type of mixer which is suitable for polymer mixtures, particularly those containing fillers. The mixture can subsequently be extruded in the form of rods, then cooled and dried in order to be shaped into granules, or the mixture can be directly formed into granules, by techniques which are well known to those skilled in the art. These granules can subsequently be introduced into a single-screw extruder in order to extrude and deposit the composition around the elongate electrically conductive element in order to form the layer in question.

The different compositions can be extruded one after the other in order to successively surround the elongate electrically conductive element and thereby form the different layers of the electric cable of the invention.

Alternatively, they can be extruded concomitantly by co-extrusion using a single extruder head; co-extrusion is a well-known process for those skilled in the art.

Whether in the step of forming granules or in the step of extrusion onto the cable, the operating conditions are well known to those skilled in the art. In particular, the temperature within the mixing or extrusion device may be greater than the melting point of the predominant polymer or of the polymer having the highest melting point among the polymers used in the composition to be employed.

### BRIEF DESCRIPTION OF THE DRAWINGS

The appended drawing illustrates the invention:

FIG. 1 schematically shows a structure in cross section of a cable in accordance with the invention according to a first embodiment.

Other features and advantages of the present invention will become apparent in light of the following examples and with reference to the annotated FIGURE, with said examples and FIGURE being given by way of non-limiting illustration.

FIG. 1 shows a schematic view of an electric cable according to a preferred embodiment in accordance with the invention.

For the sake of clarity, only those elements essential to the understanding of the invention have been shown schematically, and have not been shown to scale.

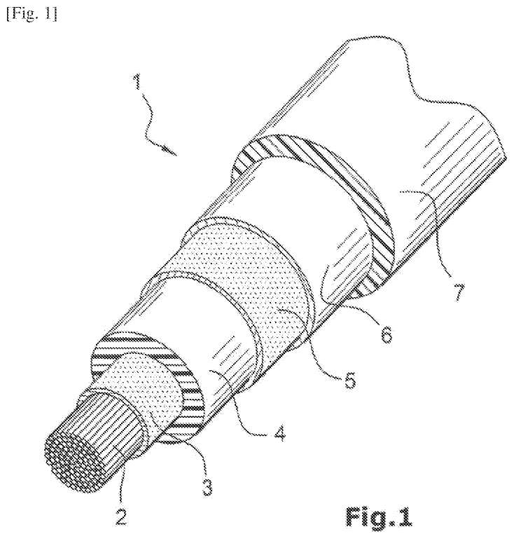

The medium- or high-voltage electric cable 1 in accordance with the first subject of the invention and illustrated in FIG. 1 comprises a central elongate electrically conductive element 2, in particular made of copper or aluminum. The electric cable 1 further comprises a plurality of layers arranged successively and coaxially around this central elongate electrically conductive element 2, namely: a first semiconductor layer 3, referred to as “internal semiconductor layer”, an electrically insulating layer 4, a second semiconductor layer 5, referred to as “external semiconductor layer”, a grounding and/or protective metal screen 6, and an outer protective sheath 7.

The electrically insulating layer 4 is a thermoplastic (i.e. non-crosslinked) extruded layer.

The semiconductor layer 3 is a thermoplastic (i.e. non-crosslinked) extruded layer obtained from the polymer composition as defined in the invention.

The semiconductor layer 5 is a thermoplastic (i.e. non-crosslinked) extruded layer.

The presence of the metal screen 6 and of the outer protective sheath 7 is preferential but not essential; this structure is well known to those skilled in the art as is.

### EXAMPLE

### Polymer Compositions

Table 1 below presents polymer compositions, for which the amounts of the compounds are expressed as percentages by weight relative to the total weight of the polymer compositions.

Composition I1 is a polymer composition in accordance with the invention, and composition C1 is a composition that represents the prior art.

TABLE 1

| Polymer composition | I1 | C1 |
|---|---|---|
| Random propylene copolymer | 47.75 | 47.75 |
| Ethylene polymer | 10 | 10 |
| Heterophasic propylene copolymer | 10 | 10 |
| Conductive filler 1: acetylene black | 25 | 0 |
| Conductive filler 2: furnace black | 0 | 25 |
| Antioxidant | 1.25 | 1.25 |
| Metal deactivator | 0.5 | 0.5 |
| Liquid dielectric | 5.5 | 5.5 |

The origin of the constituents in table 1 is as follows:
the random propylene copolymer is a random ethylene-propylene copolymer sold by LyondellBasell Industries under the reference Moplen RP210G
the ethylene polymer is an LLDPE-type polymer using hexene as comonomer, sold by INEOS under the reference BPD 3642;
the heterophasic propylene copolymer is a special ethylene-propylene copolymer, sold by LyondellBasell Industries under the reference Hifax CA7441 A
the conductive filler 1 is an acetylene black, sold by Denka under the reference Denka Black Granular;
the conductive filler 2 is a high-purity electrically conductive furnace black, sold by Orion Engineered Carbons under the reference Printex Kappa 10;
the antioxidant is an antioxidant sold by BASF under the reference Irganox B225;
the metal deactivator is a metal deactivator sold by BASF under the reference Irganox MD1024; and
the liquid dielectric is sold by Nynas under the reference Nyflex BNS 28.
   Preparation of a Strip Obtained from the Polymer Composition 11

The following constituents: liquid dielectric and antioxidant of the polymer composition referenced in table 1, are metered out and mixed with stirring at approximately 75° C. in order to form a liquid dielectric.

The liquid dielectric is subsequently mixed with the following constituents: propylene copolymer, polyethylene of the polymer composition referenced in table 1, in a container. The resulting mixture and the conductive filler are then mixed using a co-oscillating single-screw kneader (“Buss kneader”) at a temperature of approximately 145 to 180° C., then melted at approximately 200° C.

The resulting homogenized and molten mixture is subsequently cooled and formed into granules.

The granules were subsequently extruded under hot conditions in order to form a strip.

A 0.3 mm-thick strip was extruded using a single-screw extruder equipped with a flat die in order to make it possible to carry out a surface state test. The extrusion temperatures are chosen on the basis of the working properties of the polymer matrix and so as to obtain an extruded strip that exhibits virtually no deformation originating from the polymer matrix itself (e.g. unmelted areas, gels, particles originating from unwanted crosslinking, particles originating from degradation of one of the polymers of the polymer matrix). In addition, particular care is taken to avoid deformations caused by the release of volatile substances which may potentially be contained in the polymer composition. This thus makes it possible to measure protrusions or deformations which are mainly associated with the method of dispersing and distributing the conductive filler in the polymer matrix.

### Characterization of the Surface State of the Strips

The test was performed in the following manner: the extruded strip obtained above is held under constant mechanical tension by a system of rollers with regulated speed, and is brought into motion by a reel. It thus advances into a measurement area of an optical detection system which consists of a light source on one side of the measurement area and a camera on the other side of the measurement area. The detection system is oriented tangentially relative to the surface of the moving strip. The on-line camera, coupled to a camera, simultaneously records images of the surface of the extruded strip and carries out image analysis. The result is a detailed description of the number of defects present at the surface of the strip, classified by size and shape. The measurement is made by reflection. The results obtained are presented in table 2 below and indicate the number of defects or protrusions per m².

### Results

The results of the abovementioned surface state test, and of other mechanical and electrical tests, are collated in table 2 below.

The tests of breaking strength and elongation at break are performed according to standard NF EN 60811-1-1, using an apparatus sold under the reference 3345 by Instron. The breaking strength and elongation at break are measured by a tensile test on a dumbbell-shaped H2 test specimen, in particular at a pulling rate of 25 mm/min; these tests are performed in the initial state or after thermal aging in air, for example in an oven. The thermal aging conditions chosen are as follows: duration of approximately 240 hours (10 days), constant isothermal temperature of approximately 135° C.

The “PEA measurement” indicated in the table corresponds to a measurement made according to the PEA test (“Pulsed Electro-Acoustic test bench”).

The principle of the PEA electroacoustic test is to subject a dielectric sample having a charge density ρ(x) and placed between a high-voltage electrode and a ground electrode, to a pulsed electric field which causes a variation in the electrostatic forces on the electric charges contained in the sample. Since these electrostatic forces are in equilibrium with the elastic forces, the pulsed field induces the formation of elastic waves (acoustic waves). By employing a piezoelectric transducer, these acoustic waves are detected and converted into an electric signal which reflects the charge density within the sample. This electric signal is measured after amplification. It should be noted that acoustic waves are also generated at the interfaces between the sample and the electrodes, and these should not be taken into account.

More specifically, the PEA test is a dynamic measurement of the spatial distribution of charges in a solid dielectric material. In the test used, it is not an electric pulse proper which is employed, but rather a step, which makes it possible to obtain a more precise measurement. In order to induce surface charges, the stepped signal is superimposed on a DC polarization voltage. The acoustic wave resulting from the application of this voltage (DC polarization+stepped pulse) is detected by a piezoelectric sensor which in turn provides a voltage signal that contains the information reflecting the charge distribution. In order to perform the measurement at a controlled temperature, the sample, electrodes and piezoelectric sensor are placed in a temperature-controlled chamber (oven).

TABLE 2

| | I1 | C1 |
|---|---|---|
| Number of protrusions per m² | 39 | 440 |
| Maximum protrusion height in μm | 65 | 140 |
| Strength at break [MPa] | 24.9 | 23.1 |
| Elongation at break [%] | 710 | 730 |
| Strength at break [MPa] after | 22.2 | 22.1 |
| 336 h @ 135° C. in drying oven | | |
| Elongation at break [%] after | 489 | 475 |
| 336 h @ 135° C. in drying oven | | |
| Volume resistivity [Ohm*m] @ 30° C. | 0.130 | 0.038 |
| Volume resistivity [Ohm*m] @ 90° C. | 0.140 | 0.044 |
| Volume resistivity [Ohm*m] @ 105° C. | 0.150 | 0.052 |
| Result of PEA measurement (direct current): maximum | 42 | 50 |
| electric field obtained in [kV/mm] on a SC + insulator | | |
| TPHV 11 sandwich, under applied field stress of 40 | | |
| kV/mm. | | |

All these results show that the semiconductor layer according to the invention has a good surface state, in particular a smooth appearance and a very low number of protrusions, while ensuring good mechanical and electrical properties.

Above all, a significant improvement in performance in the PEA test, which is particularly important for good stability in an HVDC system, will be noted.

1. An electric cable comprising:
at least one semiconductor layer obtained from a polymer composition comprising at least 50% by weight of a propylene polymer and at most 10% by weight of polar polymer(s), relative to the total weight of polymer(s) in the polymer composition, and at least one conductive filler selected from acetylene blacks.

2. The electric cable as claimed in claim 1, wherein the polymer composition comprises at least 6% by weight of conductive filler relative to the total weight of the polymer composition.

3. The electric cable as claimed in claim 1, wherein the conductive filler is in the form of particles, nodules or aggregates, the primary particles of which have a dimension of at most 50 nm.

4. The electric cable as claimed in any one of the preceding claim 1, wherein the conductive filler has a specific surface area, according to the BET method, ranging from 50 to 150 m²/g.

5. The electric cable as claimed in claim 1, wherein the polymer composition comprises at least 60% by weight of propylene polymer(s) relative to the total weight of polymer(s) in the polymer composition.

6. The electric cable as claimed in claim 1, wherein the propylene polymer is a propylene copolymer P₁ selected from a homophasic propylene copolymer and a heterophasic propylene copolymer.

7. The electric cable as claimed in claim 1, wherein the polymer composition further comprises an olefin homopolymer or copolymer P₂.

8. The electric cable as claimed in claim 7, wherein the olefin homopolymer or copolymer P₂ is an ethylene polymer.

9. The electric cable as claimed in any one of the preceding claim 1, wherein the polymer composition comprises at most 5% by weight of polar polymer(s) relative to the total weight of polymer(s) in the polymer composition.

10. The electric cable as claimed in claim 1, wherein the polymer composition further comprises a liquid dielectric.

11. The electric cable as claimed in claim 1, wherein the semiconductor layer is a non-crosslinked layer.

12. The electric cable as claimed in claim 1, wherein said electric cable comprises at least one elongate electrically conductive element, and the semiconductor layer surrounds said elongate electrically conductive element.

13. The electric cable as claimed in claim 1, wherein said electric cable further comprises an electrically insulating layer.

14. The electric cable as claimed in claim 1, wherein said electric cable comprises:
at least one elongate electrically conductive element,
a first semiconductor layer surrounding the elongate electrically conductive element,
an electrically insulating layer surrounding the first semiconductor layer, and
a second semiconductor layer surrounding the electrically insulating layer,
at least one of the semiconductor layers being as defined in any one of the preceding claims.
